(19) United States
(12) Patent Application Publication
(10) Pub. No.: US 2021/0064820 A1
(43) Pub. Date: Mar. 4, 2021

(54) MACHINE LEARNING LEXICAL DISCOVERY

(71) Applicant: ROSOKA SOFTWARE, INC., Herndon, VA (US)

(72) Inventors: Michael Allen SORAH, Centreville, VA (US); Gregory F. ROBERTS, Herdon, VA (US)

(21) Appl. No.: 16/965,246

(22) PCT Filed: Sep. 6, 2018
(86) PCT No.: PCT/US2018/049709

§ 371 Date: Jul. 27, 2020

Related U.S. Application Data
(60) Provisional application No. 62/554,855, filed on Sep. 6, 2017.

(51) Int. Cl. G06F 40/242; G06F 40/284; G06F 40/30

(52) U.S. Cl. CPC G06F 40/242; G06F 40/30; G06F 40/284

(57) ABSTRACT

Various data or document processing systems may benefit from an improved machine learning process for information extraction. For example, certain data or document processing systems may benefit from enhanced Semantic Vector Rules and a lexical knowledge base used to extract information from the text. A method may include analyzing a set of documents including a plurality of text. The method may also include extracting information from the plurality of text based on a lexicon. In addition, the method may include updating the lexicon with at least one new term based on one or more semantic vector rules.

### CROSS REFERENCE TO RELATED APPLICATION

This application is related to and claims the priority from PCT Patent Application Serial No. PCT/US2018/049709, filed Sep. 6, 2018, which in turn claims priority from U.S. Provisional Patent Application No. 62/554,855, filed Sep. 6, 2017, both of which are hereby incorporated herein by reference in its entirety.

### BACKGROUND

Various data or document processing systems may benefit from an improved machine learning process for information extraction. For example, certain data or document processing systems may benefit from enhanced Semantic Vector Rules and a lexical knowledge base used to extract information from the text.

### DESCRIPTION OF THE RELATED ART

Reviewing data and documents for the purpose of extracting information, such as metadata, often requires the use of a lexicon or a dictionary. A lexicon may be a set of known possible meanings or states of a word or set of words. Building dictionaries and lexicons has historically been very time consuming, labor intensive, and prone to errors.

Once a lexicon is put together, a set of rules may be used to evaluate whether the text in a data set or a document set matches the content of the lexicon. A grammatical parser, for example, is a formal analysis by a computer of a sentence or string of words into its constituent parts. An analysis using a parser may at least partly rely on statistics, meaning that the parsers rely on a corpus of training data, which has already been annotated or parsed by hand. The evaluation by the parser may then result in a parse tree showing the syndication relation to each other such as a subject, a predicate, and/or the formal part of the speech, such as a noun, verb, adjective, and/or adverb. In computational linguistics, this formal representation via a grammatical parser may be useful to create meaning for lexical units. The parser may therefore provide for a standardized reference of tokens in data and/or documents as defined in a lexicon against a collection of rules.

The rules used to evaluate whether text of processed data and/or documents match a lexicon entry have traditionally been written manually. Similar to the problem involved with building dictionaries and lexicons manually, this manual processing is very time consuming, labor intensive, and prone to errors. In addition, the rules have relied heavily on statistics, without providing an explanation to the user as to how a particular text is being evaluated, beyond a mere statistical representation of a correlation.

### SUMMARY

According to certain embodiments, a method may include analyzing a set of documents including a plurality of text. The method may also include extracting information from the plurality of text based on a lexicon. In addition, the method may include updating the lexicon with at least one new term based on one or more semantic vector rules.

In a variant, the method may include providing a report including the extracted information to a user. The report may include one or more semantic vector rules.

In a variant, the method may include displaying the report including the extracted information to the user.

In a further variant, the method may include displaying the at least one new term to a user. The method may also include requesting in a supervised mode for the user to affirm or not affirm the at least one new term.

In an additional variant, the displaying of the report occurs after the analyzing of the plurality of text.

In another variant, the method may include updating the lexicon with the at least one new term in an unsupervised mode, wherein the updating may occur during the analyzing of the plurality of text.

In a further variant, the semantic rule state evaluation may be based on shared context.

In a variant, the report may include a trace back illustrating the one or more semantic rules used to extract the information.

According to certain embodiments, an apparatus may include at least one processor, and at least one memory including computer program code. The at least one memory and the computer program code may be configured to, with the at least one processor, cause the apparatus at least to analyze a set of documents including a plurality of text, extract information from the plurality of text based on a lexicon, and update the lexicon with at least one new term based on one or more semantic vector rules.

In a variant, the at least one memory and the computer program code may further be configured to, with the at least one processor, cause the apparatus at least to provide a report comprising the extracted information to a user, wherein the report includes one or more semantic vector rules.

In another variant, the at least one memory and the computer program code may further be configured to, with the at least one processor, cause the apparatus at least to display the report comprising the extracted information to the user.

In a variant, the at least one memory and the computer program code may further be configured to, with the at least one processor, cause the apparatus at least to display the at least one new term to a user, and request in a supervised mode for the user to affirm or not affirm the at least one new term.

In another variant, displaying of the report occurs after the analyzing of the plurality of text.

In a further variant, the at least one memory and the computer program code may further be configured to, with the at least one processor, cause the apparatus at least to update the lexicon with the at least one new term in an unsupervised mode. The updating occurs during the analyzing of the plurality of text.

In a variant, a semantic rule state evaluation may be based on shared context. In another variant, the report may include a trace back illustrating the one or more semantic rules used to extract the information. In a further variant, the extracted information may include one or more entities.

According to certain embodiments, an apparatus may include means for analyzing a set of documents including a plurality of text, means for extracting information from the plurality of text based on a lexicon, and means for updating the lexicon with at least one new term based on one or more semantic vector rules.

According to certain embodiments, a non-transitory computer-readable medium may encode instructions that, when executed in hardware, perform a process, the process including analyzing a set of documents including a plurality of text, extracting information from the plurality of text based on a lexicon, and updating the lexicon with at least one new term based on one or more semantic vector rules.

According to certain embodiments, a computer program product may encode instructions for performing a process, the process including analyzing a set of documents including a plurality of text, extracting information from the plurality of text based on a lexicon, and updating the lexicon with at least one new term based on one or more semantic vector rules.

According to certain embodiments, a computer program, embodied on a non-transitory computer readable medium, the computer program, when executed by a processor, may cause the processor to analyze a set of documents including a plurality of text, extract information from the plurality of text based on a lexicon, and update the lexicon with at least one new term based on one or more semantic vector rules.

### BRIEF DESCRIPTION OF THE DRAWINGS

For proper understanding of the invention, reference should be made to the accompanying drawings, wherein:

FIG. 1 illustrates a system diagram according to certain embodiments.

FIG. 2 illustrates discovered lexical entries according to certain embodiments.

FIG. 3 illustrates a system diagram according to certain embodiments.

FIG. 4 illustrates a flow diagram according to certain embodiments.

FIG. 5 illustrates a semantic vector rule distribution according to certain embodiments.

FIG. 6 illustrates a semantic vector rule in XML according to certain embodiments.

FIG. 7 illustrates a graphic state diagram according to certain embodiments.

FIG. 8 illustrates a flow diagram according to certain embodiments.

FIG. 9 illustrates a flow diagram according to certain embodiments.

FIG. 10 illustrates a system according to certain embodiments.

### DETAILED DESCRIPTION

Certain embodiments may provide for extracting the plurality of text using a lexicon, and updating the lexicon using a machine learning process. The machine learning process may be performed either in a supervised or an unsupervised mode. In the supervised mode, the lexical items that have been discovered via semantic vector rules may be reviewed for correctness following the review of the data set and/or set of documents. In some other embodiments, in the unsupervised mode, lexical items that have been discovered through the contextual use are fed back into the lexicon, without requiring any human intervention. In other words, the lexicon can be upgraded using machine learning without any human supervision during the ongoing review of the data set and/or set of documents.

In some other embodiments, the Semantic Vector Rules may be used to extract information from a plurality of text using a lexicon. The Semantic Vector Rules may be updated and/or upgraded to include new rules via a machine learning process. Instead of manually having to update the Semantic Vector Rules, certain embodiments may allow for the automated refinement of rules used to evaluate a plurality of text. While the lexicon merely includes a list of the meaning of various words or tokens in a vector space, the Semantic Vector Rules may be used to determine how an extraction engine decides that a set of documents includes an entity.

A machine learning process may be used for discovery of the parts of speech, pragmatic meaning, and entity extraction. Entities may include people, places, organization, weapons, drugs, and/or things. In reviewing a set of data and/or documents, a reviewing process may attempt to extract such entities using at least one of a lexicon or Semantic Vector Rules. In certain embodiments, the initial lexicon may have a small seed set of lexical entries. The small seed lexical entries are a list of the common most N words in a language, or any extended lexicon having a greater size. The minimum size may be dependent on the specific language, but N may range between 6,000 and 12,000 words, for example.

The small seed set of lexical entries may be expanded using machine learning in order to populate the lexicon. Certain embodiments may remove the need for a person to manually hand tag and enter lexical entries obtained from a dictionary or other reference. As such, the time and labor resources needed for updating the lexicon may be reduced.

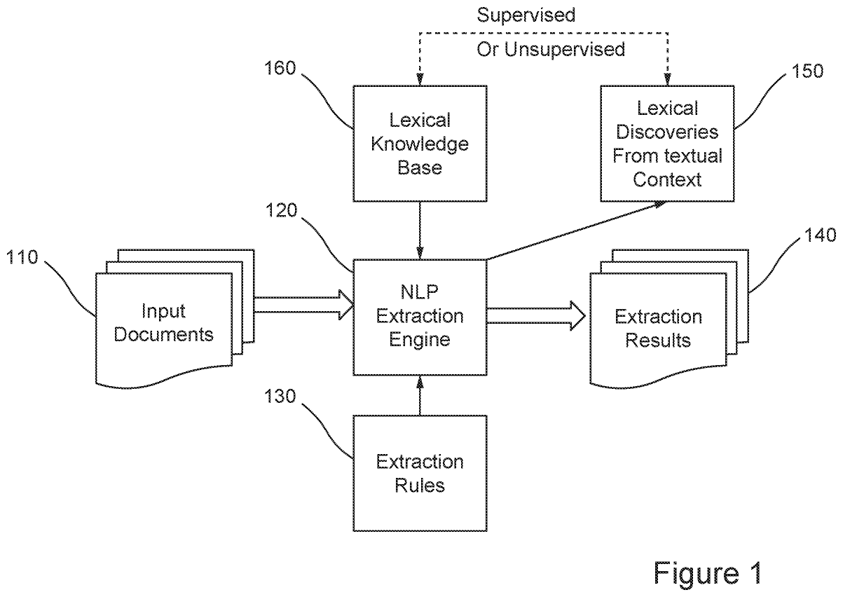

FIG. 1 illustrates a system diagram according to certain embodiments. A set of input documents 110 may first be inputted into a Natural Language Processing (NLP) extraction engine 120. The set of documents, in some embodiments, may be in the form of electronic files and/or data. NLP extraction engine 120 may use a set of extraction rules 130, such as Semantic Vector Rules, to evaluate and extract information from a set of inputted documents. The extracted information may be parts of speech, pragmatic meaning, and/or entities, such as people, places, and/or things. The results of the extraction 140 may be outputted and displayed to a user. The displayed results may be in the form of a report that includes a trace back, which allows a user to view one or more rules used to determine that a set of documents includes the extracted information. In certain embodiments, the trace back may allow a user to determine whether or not a given Semantic Vector Rule should be used for the machine learning feedback or not. For example, a problematic Rule can be turned off for machine learning while other Rules may be allowed.

A lexical discovery 150, also known as a new lexicon entry, may be determined based on the textual context of a plurality of text in a document during the extraction process. A lexical dictionary may be a set of known possible meanings or states for a word or set of words, referred to as a semantic vector (SV). This may allow the storage of possible meanings for a set of words as a lexicon or a dictionary. A set of words, word, or a part of a word in a lexicon or a dictionary may be referred to as a token. For example, the word “by” can be an adverb, a preposition, and a locative preposition. The word may be stored as a token in an extensible markup language (XML) format. In other embodiments, any other set of format, such as an extensible hypertext markup language (XHTML), may be used. The XML format may be stored as follows: <lex><word>by</word><sv><adverb/><prep/><locativeprep></sv></lex>.

Certain embodiments may use a vector space of possible interpretations of a stream of tokens or words. A vector space may be a generic term referring to a set of numbers for which mathematical operations, such as multiplication and/or addition, may be applied. A state-space may be a mathematical model of a system as a set of variables that can be represented as a vector. A semantic vector may be a representation of state of possible meanings or interpretations of a word or set of words. For example, the word “the” can be a determiner or an adverb.

Utilizing a semantic vector may allow for the creation of a vector space of state possibility for each token or set of tokens in a token stream. In this vector space, a token may have multiple possible meanings at any step in the process, and the one or more meanings may change during this processing. The vector space, for example, may be finite in that it is predicable and repeatable. The vector space itself may be defined as having a given length, and each position in the vector may be defined at runtime. The semantic vectors, on the other hand, may be nonfinite because they represent a set of possible states that change during processing based on the surrounding vectors. The Semantic Vector Rules may therefore be a cross between finite state rules and nonfinite state rules.

The Rules, in some embodiments, may operate on the semantic vectors to enable or disable particular portions of the vector space, based on an individual token's vectors and/or surrounding tokens or vector. In other words, each token may have its own vector space, and the Semantic Vector Rule may act to enable or disable particular portions of the vector space. In certain embodiments, the vector space for a token may be represented by at least the following states: is, isnot, true, false. The vector, therefore, may be represented by is true, is false, isnot true, and/or isnot false, which in effect provides more granularity in the Semantic Vector Rules. Is true and isnot false may occupy two different positions on the semantic vectors.

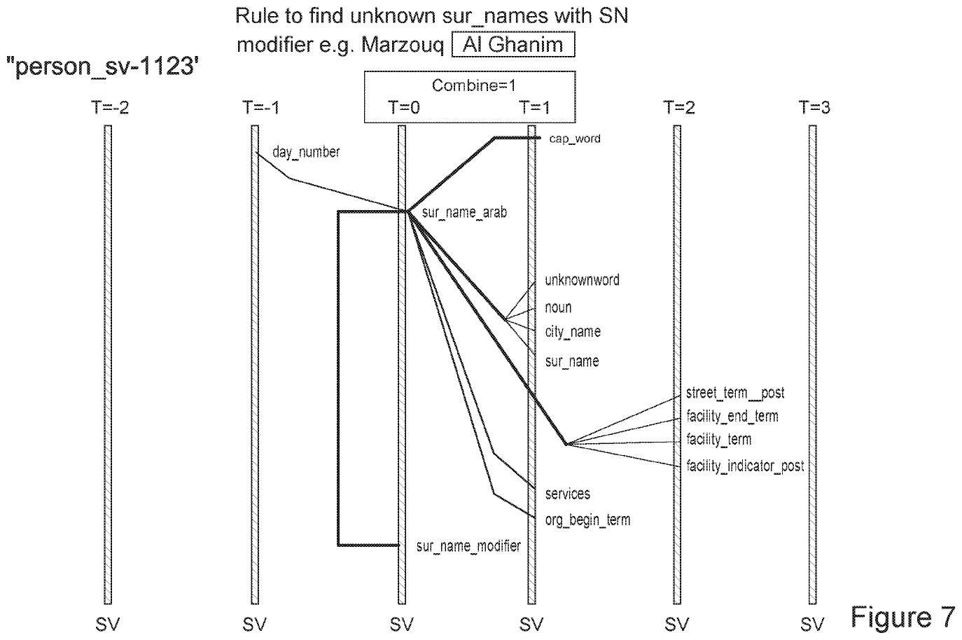

The quantum spectrum of the vector space may represent the intended meaning of the sender, using the is or the isnot states, and an interpretation of the receiver, using the true or the false states. The vector space can also be modified post hoc through the process of recursion, based on changes to a particular vector or its surrounding vectors. Recursion may provide a form of back chaining, looking ahead or backwards to change the meaning in the form of a semantic vector as words or tokens in the string of words or tokens are encountered. An illustration of recursion may be seen in FIG. 7.

In a real world example, without the use of machine learning, a reader may encounter a word while reading a novel. A dictionary definition of a given word within the novel may indicate multiple possible meanings of the same word. Upon encountering the word while reading the novel, a reader of the novel may need to decide which definition is most likely based on the context of its usage. A dictionary may show that the definition of “can” may be as follows: (noun) a type of container, (verb) indicating ability, (verb) to fire, (verb) modal, (noun) abbreviation for Canada, (Navy slang) a destroyer, (common typo) other words with near spellings such as “cane” or “scan.” Using the available contextual information, as well as the shared context with the sender, the reader may determine the intended meaning of the signal. Certain embodiments help to simulate this process in a machine environment, while also incorporating various machine learning processes.

Certain embodiments may be a multidimensional transient state vector machine, because the semantic vectors may change based on the surrounding vectors during a state of the processing. The initial state may be established through a lexical lookup for each token or contiguous sets of tokens to see if there are semantic vectors defined in its lexicon. The token sequence may then be compared or matched to the Semantic Vector Rule set to find the first applicable rule. When a rule matches, the rule may be applied to the token sequence. The rule make change the vector state of the token, or it may combine sets of tokens to make a new token with a new vector space.

An example of a token stream may be an authorship line of an article including 3 tokens, such as “By,” “John,” and “Hancock.” The lexicon may set the Semantic Vector space as follows: <lex><word>by</word><sv><adverb/><prep/><locativeprep></sv></lex> <lex><word>john</word><sv><given_name/><given_name_male/><sur_name/></sv></lex>. “Hancock” may not be known to the lexicon, in some embodiments, so it may not be assigned. Because “Hancock” is not know, it may be assigned the following vector space: <lex><word>Hancock<word><sv><unknown></sv></lex>.

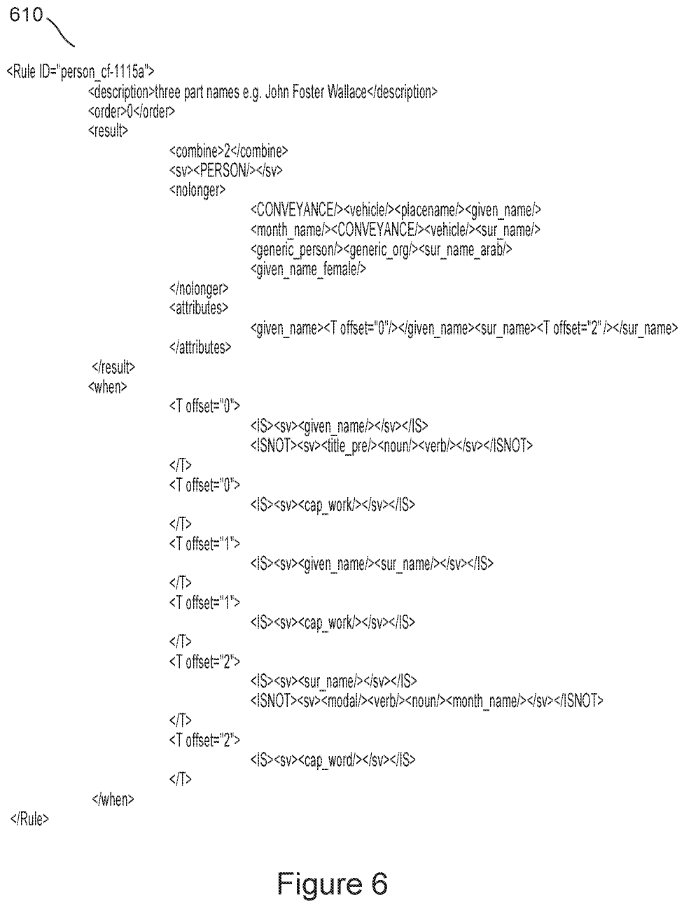

In certain embodiments, a Semantic Vector Rule may tell NLP Extraction Engine 120, that when there is a preposition followed by a given name and then by a unknown word, the engine may combine the given name and unknown word to a new token, set the vector to a person, and turn off the other vectors states for the prepositional phrase. Another example of a Semantic Vector Rule may be illustrated in FIG. 6. After processing, the token stream may be represented as follows: <lex><word>by</word><sv><prep/></sv></lex> and <lex><word>John Hancock</word><sv><PERSON></sv></lex>.

In contrast to using a parser, the extraction of the term “Hancock” as a surname in the above embodiment may not only modify the vector on the tokens but also modifies the token stream. For this processing state, when the extraction engine encounters the term “Hancock,” rules that would apply to unknown words, surnames, or given names would no longer be applicable, and would no longer need to be checked. In certain embodiments, the lexicon may include not only a typical part of speech tags, but also pragmatic tags that allows for processing short cuts, for example given_names. The pragmatic parts may allow for bypassing processing states, and therefore require less computational energy. For example, there may be no need to define the term “John” as a noun or a pronoun, because it is not relevant to the information content.

Certain embodiments may allow for a “not” vector space to be used as part of the Semantic Vector Rule. For example a <not_given_name/> may be used, which is different and distinct from the <given_name> being false. These “not” vectors can be used for improving accuracy of the extraction results.

In some embodiments, once the term “John Hancock” is determined to be a person, the term and the associated entity type may be displayed to a user in a supervised mode after review of the set of documents is complete. The user may then determine whether or not the derived entity associated with the term is correct. If the derived entity is correct, the user may indicate an affirmative response, and term may be stored as part of the lexicon. If the derived entity is not correct, the user may indicate a negative or a non-affirmative response, and the term may be discarded. On the other hand, in an unsupervised mode, instead of displaying the term and the associated entity type to the user, the system may automatically update the lexicon to include the term and the associated entity type. In an unsupervised mode, the lexicon may be updated during review of the document set. While in the supervised mode, however, any additions to the lexicon may not be made until after the review of the document set may be complete.

Some embodiments may allow for a semi-supervised mode. The semi-supervised mode may allow for a user in a supervised mode to select a semi-supervised option, such as a “stop asking me about the ones from this rule, just update the lexicon.” In this semi-static mode, some tokens may be automatically added to the lexicon, in an unsupervised matter, while other tokens may only be added after an affirmation by the user, similar to the above discussed supervised mode.

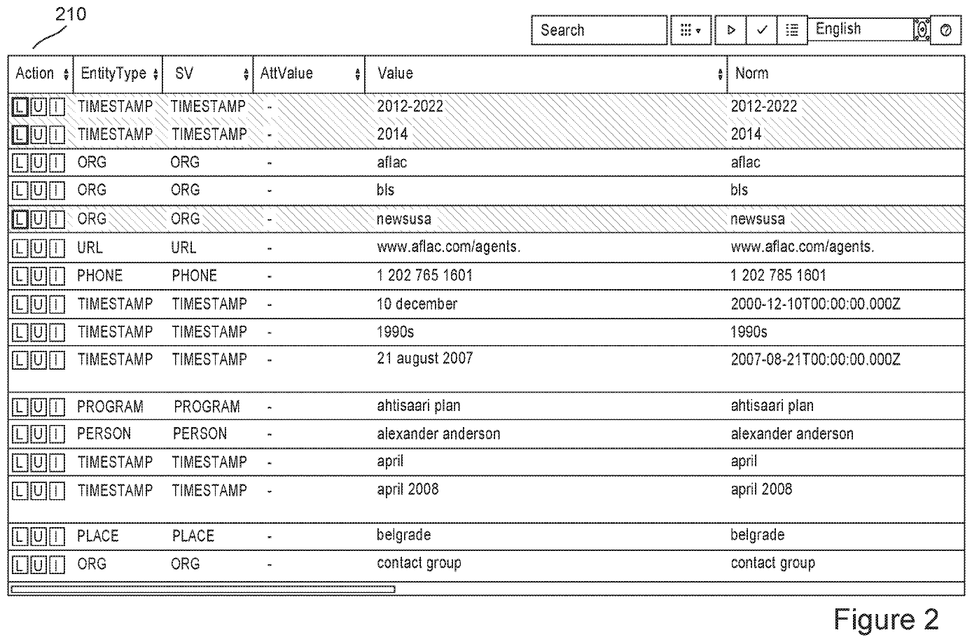

FIG. 2 illustrates discovered lexical entries according to certain embodiments. In particular, FIG. 2 illustrates an example of a lexicon interface 210 that includes an action column, an entity type column, a semantic vector column, a value column, which may be the term itself, and a norm column. For each row, there may be the following three action buttons from which a user can choose: [L] which is chosen to allow the lexicon to learn the item; [U] which is chosen so that the lexicon “unlearns” or more precisely learn that something is not that item; and/or [I] which is chosen so that the lexicon ignores learning or unlearning the item for now. The lexicon interface may be displayed to a user, and may include at least part of the lexicon. The lexicon interface 210, in some other embodiments, may only include new tokens or words added to the lexicon. For example, similar to the value “Alexander Anderson,” the term “John Hancock” would also be identified as an entity type. In a supervised mode, the user may have to confirm that the correct entity type was assigned to the term, while in an unsupervised mode the assigned entity to the term may be assumed correct and added to the lexicon.

Human language learning may typically demonstrate three type of knowledge, including at least one of rote knowledge, compositional knowledge, and dynamic knowledge. Because the extraction engine may change state and/or alter the token stream, which may be in the form of a vector space, the extraction engine may be able to leverage one or more of these three types of knowledge. Rote knowledge, for example, may be the knowledge that is inscribed in the lexical lookup tables. Such rote knowledge may be represented by values associated with each token or set of tokens captured in the lexicon. In other words, rote knowledge may simply be knowledge that is known and encoded in the lexicon.

Compositional knowledge, for example, may be the knowledge encoded in localized canonical rules used to interpret the meaning of a token or collection of tokens. An entity, such as John Smith, may be recognized as a person because of the component pattern of a given name plus surname, similar to the example provided above regarding John Hancock. John may be a known given name, and Smith may be a known surname. The two tokens together may comprise a valid name regardless of whether both names have been encountered together before. Any combination of names and known surnames may be a valid match.

Dynamic knowledge may be represented by rules that need a larger linguistic context to determine the appropriate interpretation. For example, in a sentence like “Chinua Achebe is a Nigerian author,” the name Chinua Achebe may be easily recognized as a person because of the linguistic context, which dictates that authors tend to be people. Even when the tokens Chinua and Achebe are unknown in the lexicon, certain embodiments may extract the entity using the context. Once Chinua Achebe is recognized as a novel name, the term may be extracted in other less semantically rich contexts. In other words, recognition of the term Chinua Achebe may be converted from dynamic information to rote information, which takes less computational energy to determine.

Converting dynamic discovery to rote information may be based on the balance between the degree of fitness for computational efficiency, and more complex rules used to recognize the relatively rare occurrence of high value information. The entropy may be based on the amount of computational effort to deal with false positives and the consequences of missed information. For example, once Chinua Achebe may be identified as a person name, it may be recognized using a very inexpensive rote rule, and more complex, costly rules are not needed. Because the term is now lexicalized, certain embodiments may skip using a rule to find the name based on its components, as well as a far more expensive rule that uses sentential context.

Users may therefore be allowed, in some embodiments, to vet values that are discovered dynamically to be either incorporated into the lexicon or “unlearned” as not a statement. Unlearned, for example, may mean that the statement is not a surname. This vetting feature may be important because for very large sets of documents, which may include millions of pages with a plurality of texts, the phenomena of false positive may creep, or reduce precision, that occurs when statistical learning systems process large data sets. Certain embodiments, however, eliminate the need to hand tag large sets of training data, and allow for self-tagging of the data using the extraction engine.

In certain embodiments, the Semantic Vector Rules may, in part, resemble classic linguistic rules because they parallel the way humans understand and interpret language. However, there are significant advantages presented by the embodiments discussed above. For example, certain Semantic Vector Rules may include instructions regarding how many tokens to combine and which semantic vectors to set or unset when a rule matches. The rule specific attributes may be tracked with the tokens and the is or isnot conditions for the token stream. An individual token's position in the token stream may be expressed as a relative offset.

The Semantic Vector Rules may be expressed in Boolean form, but may be expressed in a quad state of is/isnot and true/false, with true indicating that the vector positional name is present in the tag, and false indicating that it is not present. The Semantic Vector Rules therefore allow a writer of the rule to think of the Boolean equivalent, with logical AND/OR. The AND condition is akin to having multiple conditions for a token, and the OR condition is akin having multiple items in the <sv> list.

In certain embodiments, the Semantic Vector Rules may be used for multilingual processing. Since the Semantic Vector Rules may not be tied to a parser, but instead utilize a vector space, the extraction engine may be used for multiple different languages. Certain embodiments may utilize a lexical mapping to a semantic vector space in multiple different languages. For example, if a Korean document contains “ [symbol] ” it will have the same semantic vector as Vladimir Putin in English. Or “ [symbol] ” has the same vector as Department of State in English, as well as the transliteration of guo wu yuan.

The engine, therefore, may not care what language the tokens stream is using, only the word sense order. Word sense order may provide vector pattern sequences, which may be matched against the semantic vector space. In other words, the matching may be dependent upon a word sense order. Thus, the extraction engine may be processed, without requiring an intermediate translation, and the accuracy, or precision and recall, may only be dependent on the breadth of the lexical entries for a given language.

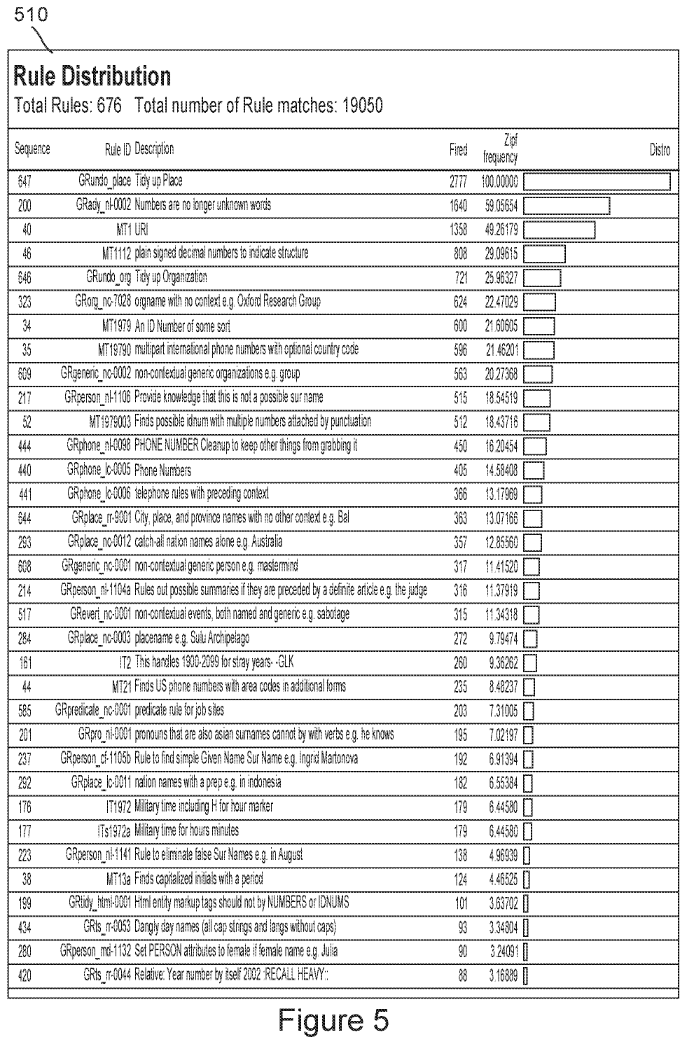

In some embodiments, a Zipf power law distribution may be used to predict the Semantic Vector Rule based on a vector space. Zipf, also referred to as Zipf-Mandlebot or zeta distribution, may be a frequency distribution of sets of items that can be rank ordered. A Zipf frequency can be seen in FIG. 5, for example. Languages may have a few words that are used with high frequency, such as “the” or “of,” a greater number of words that get used with lower frequency, such as “butter” or “joke,” and a vast number of words that hardly ever get used at all, such as “defenestrate, lubricate, and mascaron.” Grammatical rules may follow this same type of distribution.

Because the Semantic Vector Rules may also follow the Zipf distribution, a small number of rules may provide a very high level of comprehension. Unlike other tools that use parser-based rule systems, certain embodiments may successfully extract entities using just a few hundred Semantic Vector Rules. Rules beyond the basic out of the box capability may become either exception handling or domain-specific pattern recognition rules. Additional rule writing can rapidly approach a point of diminishing marginal returns.

By contrast, training a statistically-based learning machine on these high value, yet infrequent patterns, may require providing a statistically significant number of examples, which, given the inherent infrequency of such information, represents a significant number of resources. The extraction engine, in certain embodiments, may leverage at least quantum vector space of state possibilities and/or the Zipf distribution of lexical and linguistic pattern frequency to provide a uniquely efficient and effective method of entity extraction. Certain embodiments also allow for multiple possible meanings throughout processing, with use of a vector space, recursive pattern matching, and the addition of domain-specific rules with negligible additional processing cost.

In some embodiments, since information extraction using the Semantic Vector Rules allows for the recognition of semantic vector states, which may not have necessarily matched with the original vector states stored in the lexicon knowledge base, the outputted report or results may be compared against the original lexicon. When there is a difference in the two states, these changes may be put back into the lexical knowledge base to account for the difference and/or the change.

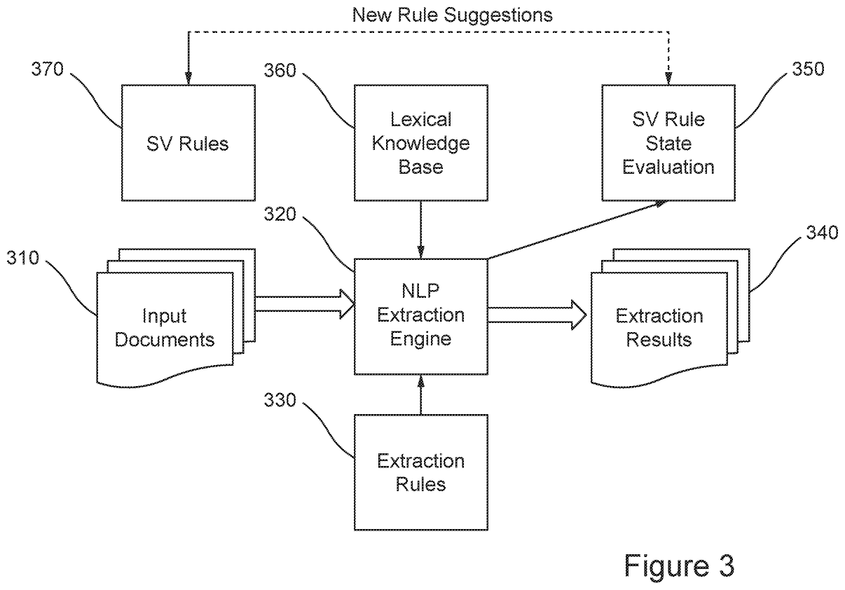

FIG. 3 illustrates a system diagram according to certain embodiments. In particular, FIG. 3 illustrates a system in which machine learning may be used to determine a new Semantic Vector Rule. Input documents 310, extraction engine 320, extraction rules 330, extraction results 340, and lexical knowledge base 360 may be equivalent, in some embodiments to those same entities shown in FIG. 1. Instead of the lexical discoveries from textual context, as shown in FIG. 1, however, FIG. 3 may evaluate and suggest new Semantic Vector Rules. As shown in FIG. 3, the system may include a Semantic Vector Rule State Evaluation 350 and a Semantic Rule 370.

A Semantic Vector Rule State Evaluation 350 may evaluate the extracted information based on shared context. Shared context, for example, may include at least a lexical understanding, linguistic rules, and/or information or experience that may be shared between the sender and the receiver. The information or experience may be determined based at least on world knowledge, personal experiences, and/or prior agreement.

Once the set of documents have been fully processed by extraction engine 320, the proposed new rule suggestion may then be displayed to the user. The user may then review the proposed new rule suggestion and indicate approval or disapproval of the rule. Similar to the supervised embodiments associated with the lexicon update as discussed above, the user may either approve of the new rule suggestion or disapprove of the new rule suggestion. When a user approves the new suggested rule, the rule may be incorporated into the extraction rules 330 used by extraction engine 320.

Certain embodiments may provide a machine learning tool that may construct semantic vectors based on a token and evaluate the semantic vectors based on one or more surrounding tokens. A new rule may then be constructed that would then change the semantic vector state on the token, or surrounding tokens, and/or combine tokens to form a new token.

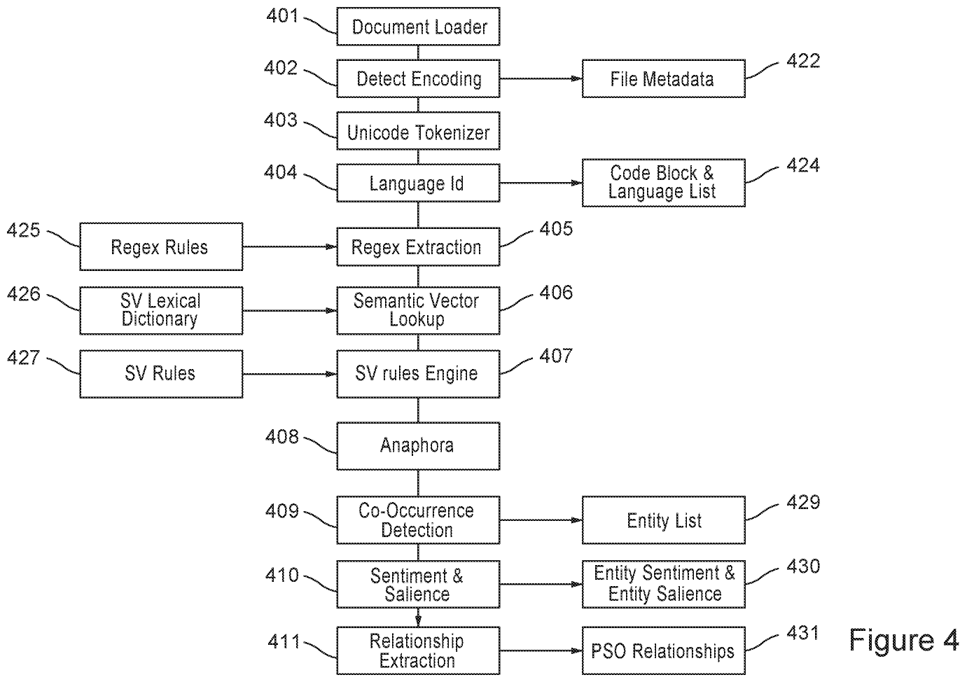

FIG. 4 illustrates a flow diagram according to certain embodiments. In particular, FIG. 4 illustrates an embodiment of the entity extraction method regardless of the language of the documents being evaluated. For example, in step 401 the set of documents/data may be loaded into extraction engine 320 via a document loader. The set of documents/data may include a plurality of text in a variety of languages. In step 402, the extraction engine may detect encodings included within the set of documents. The extracted encodings may then be filed as metadata in step 422.

One or more unicode tokenizers may then be applied to the document set, in step 403. The unicode tokenizers may be used to map the text into different unicodes, which may include one or more letters, numbers, or symbols. For example, a word may be divided into silent letters included within the word and/or letters that distinguish plural and singular words. In other embodiments, Unicode tokenizer may recognize numbers and/or various punctuation marks. In step 404, the extraction engine may recognize the language identification of the plurality of text. For example, the engine may determine whether the text being processed is in English, Spanish, Korean, Russian, or any other language. In certain embodiments, a language list along with a code block, may be used to identify the language, as shown in step 424. For example, the Unicode code block of “Cherokee” may only be used for the Cherokee language, while the “Basic Latin” Unicode code block may only be used for English, Spanish, Italian, and/or French. One or more pattern matchers may be used to determine the differences between languages. For example, in some languages a noun may be placed before the adjective, while in other languages the noun may be placed after the adjective.

In step 405, a regular expression (Regex) extraction may be performed by the extraction engine. The extraction engine may use one or more Regex Rules to perform the extraction. Regex Rules may be straight forward pattern match rules, which may not utilize linguistic rules. A Semantic Vector Lookup may then be performed in step 406. The Semantic Vector Lookup, in step 406, may rely on the Semantic Vector Lexical Dictionary 426. The Lexical Dictionary 426 may be the lexicon knowledge base shown in FIG. 1. In step 407, the Semantic Vector Rules Engine may then be used to process or evaluate the plurality of texts using Semantic Vector Rules 427. An example of a Semantic Vector Rule may be seen in FIG. 6.

In step 408, one or more anaphora may be used to evaluate the plurality of text being processed. An anaphora may map antecedent basis between different terms or associate pronouns to the noun to which they are referring. For example, the phrase “Mr. Smith” may be evaluated to determine that the surname Smith should be connected to a male. In another example, the pronoun “he” may be associated with “Mr. Smith.”

In step 409, a co-occurrence detection may occur in which the extraction engine may evaluate whether any of the plurality of text matches an entity within entity list 429. Co-occurrence detection may include evaluating matches based on items discovered through the rules that may or may not be in the lexicon, as well as anaphoric references. In step 410, the extraction engine may evaluate salience and sentiment in the plurality of texts, using an entity sentiment and entity salience 430. In step 411, the extraction engine may extract a relationship, and then forward the Predicate Subject Object (PSO) relationships 431. In PSO, the relationship between two entities, such as a subject and an object, may be captured.

FIG. 5 illustrates a semantic vector rule distribution according to certain embodiments. In particular, FIG. 5 shows a distribution chart 510 illustrating the frequency of matching the plurality of texts with Semantic Vector Rules. As can be seen in FIG. 5, the use of Semantic Vector Rules may be distributed according to a Zipf frequency, with some rules getting used more often than others.

In certain embodiments, the semantic vector space may allow for multiple conditions on the vector to be simultaneously checked. For instance, it may not be necessary to check every possible condition for finding a person's name. Once a rule has matched, the vector space may change to indicate a person, which may make additional checks unnecessary. As such, in some embodiments thousands of classic rule conditionals may be collapsed into a single vector space rule, which requires less entropy to process. Therefore, the above embodiments may only require a small number of rules. For example, certain embodiments may have hundreds of Semantic Vector Rules, while traditional pattern based tools have tens of thousands of rules required to accomplish the same tasks.

FIG. 6 illustrates a semantic vector rule in XML according to certain embodiments. Specifically, rule 610 as shown in FIG. 6 may be related to determining a person based on a three part name, for example, John Foster Wallace. This semantic rule shown in FIG. 6 may be similar to the semantic rule used to determine that John Hancock is a person. Once that determination is made, John Hancock may be added as a new lexicon entry, while being designated as a person.

As discussed above, a Semantic Vector Rule may be matched against the vector space sequence of the rule, as opposed to a mere determination of whether a rule is activated or not. If the pattern matches the Vector Space Rule applies, but if the pattern does not match, the Vector Space Rule may not apply. Therefore, Rules that do not apply need not even be evaluated. Certain embodiments may therefore provide for savings related to the computational throughput speed.

Certain embodiments may use a rule precedence fall-through methodology. In such embodiments, Rule order may be paramount to processing success. Under such systems, adding additional Rules may mean that the entire rule order chain may be re-evaluated to prevent entire logic branches from unintentionally being ignored. Using Semantic Vector Rules to evaluate a plurality of texts may allow for avoiding the need to add a linear-to-exponential amount of processing computation for each new rule added.

The extraction engine may also allow users to vet values that are discovered dynamically to be either incorporated into the lexicon or “unlearned” as a not statement. This vetting feature may be important because for very large sets of documents false positive creep, or reduction in precision, that occurs when statistical learning systems process large data sets. Additionally, certain embodiments may eliminate the need to hand tag large sets of training data, while effectively self-tagging.

Once a new Semantic Vector Rule is determined, the final token string used by the extraction engine to evaluate the plurality of text may be included in the outputted report to the user. The output may then be evaluated for correctness and any place where a different outcome is desired for a token. The semantic vector state and the surrounding token vector states may also be evaluated to determine what the desired output should be. A new rule can then be generated based on these Semantic Vector state conditions so that when these set of vector states are encountered again the new vector state changes can then be applied.

FIG. 7 illustrates a graphic state diagram according to certain embodiments. In particular, FIG. 7 may illustrate a graphic state diagram evaluating the name “Marzouq Al Ghanim.” Particular, Semantic Vector Rules may be used to find the unknown surname “Al Ghanim.” A first token (T=0) “Al” may be evaluated. As can be seen in FIG. 7, the Rules recognize that the term “Al” may be a sur_name_arab and/or a sur_name_modifier. A second token (T=1) “Ghanim” may then be evaluated. The Semantic Vector space, and the rules reflected therein, may be seen in FIG. 7. In addition, to evaluating the plurality of texts, the surrounding tokens in T=−1 and T=2 may also be evaluated. When displaying the outputted determination to the user, the report may include not only the evaluated tokens but also the surrounding tokens.

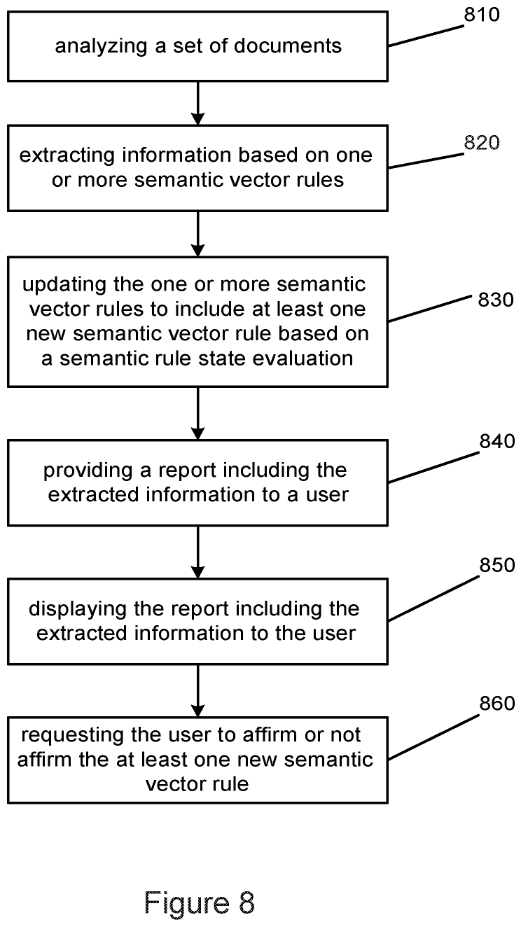

FIG. 8 illustrates a flow diagram according to certain embodiments. Specifically, FIG. 8 illustrates an embodiment of machine learning for updating semantic vector rules. In step 810, a server may analyze a set of documents including a plurality of text. In step 820, a server may extract information from the plurality of text based on one or more semantic vector rules. The extracted information may be a set of entities, for example. The extracting of the information may include matching the semantic vector rules with a vector space sequence of the plurality of the text. In step 830, the server may update the one or more semantic vector rules to include at least one new semantic vector rule based on a semantic rule state evaluation. The semantic rule state evaluation may be based on shared context.

In certain embodiments, a user may discover the new semantic vector rule based on the semantic rule state evaluation. For example, when a user finds a word or set of words that they think should be an entity but was missed in the report, or wants to set up a new entity type, they would highlight the word or set of words and click an action button to launch the rule discovery tool. The rule discovery tool may then provide a suggestion of possible rules based on the word or set of words semantic vectors and/or the surrounding word semantic vectors. The new semantic vector rule may be displayed to the user, who may then either affirm or not affirm the displayed new semantic vector rule.

In step 840, the server may provide a report including the extracted information to a user. The report may include at least one new semantic vector rule. A display may then display a report including the extracted information to the user, as shown in step 850. The report may include a trace back illustrating the one or more semantic rules used to extract the information. In step 860, the user may be requested to affirm or not affirm the at least one new semantic vector rule. The user may also review the report and/or the inputted plurality of text to discover a new semantic vector rule.

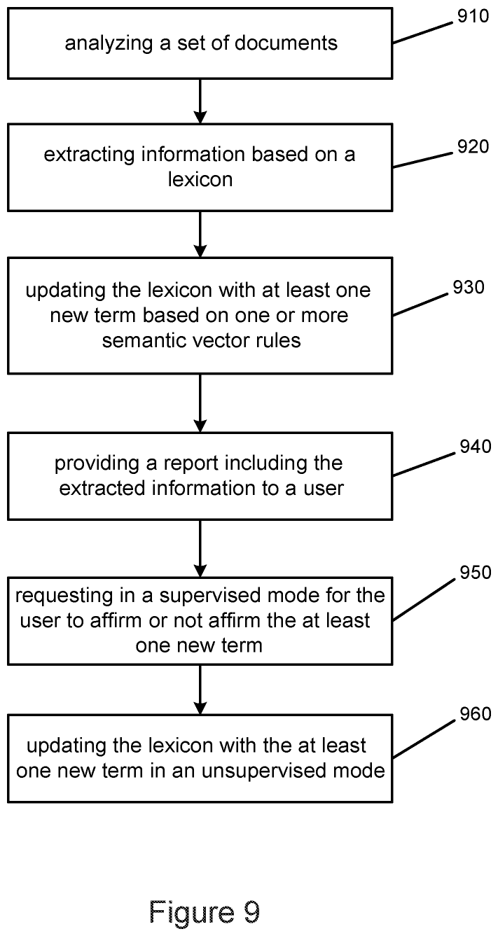

FIG. 9 illustrates a flow diagram according to certain embodiments. Specifically, FIG. 9 illustrates an embodiment of a machine learning lexical discovery. In step 910, the server may analyze a set of documents including a plurality of text. In step 920, the server may extract information from the plurality of text based on a lexicon. The lexicon may then be updated with at least one new term based on one or more semantic vector rules, in step 930.

In step 940, the server may provide a report including the extracted information to a user. The report may include one or more semantic vector rules. In step 950, the report including the extracted information may be displayed to a user. In step 960, the report may include displaying the at least one new term to a user, and requesting in a supervised mode for the user to affirm or not affirm the at least one new term. The displaying may occur after the analyzing of the plurality of text. In certain other embodiments, the lexicon may be updated with the at least one new term in an unsupervised mode. The updating may occur during the analyzing of the plurality of text.

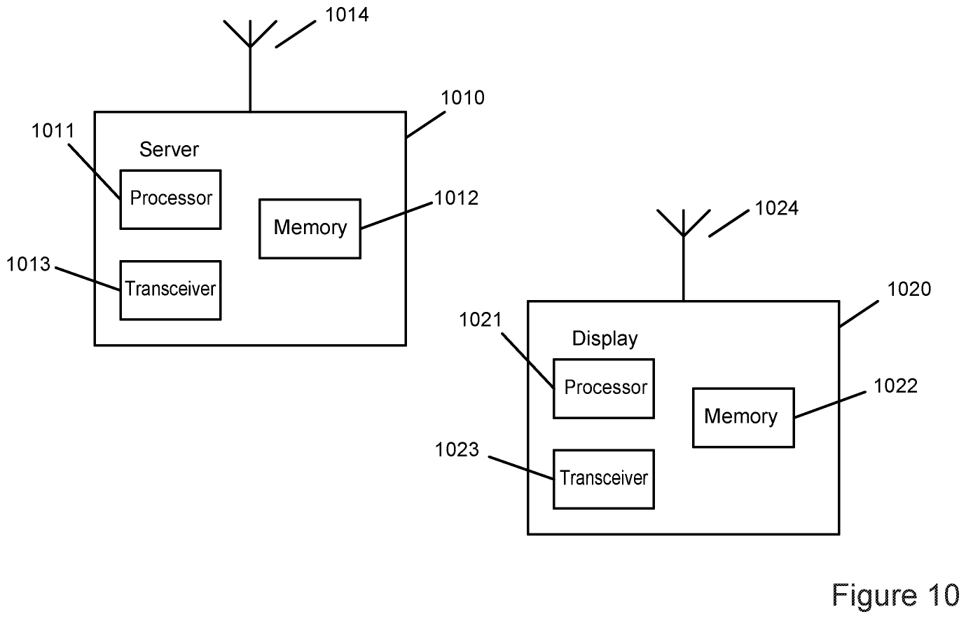

FIG. 10 illustrates a system according to certain embodiments. It should be understood that each signal, diagram, chart, or block in FIGS. 1-9 may be implemented by various means or their combinations, such as hardware, software, firmware, one or more processors and/or circuitry. In one embodiment, a system may include several devices, such as, for example, a server 1010 or a display 1020. The system may include more than one displays 1020 and more one server 1010, although only one of each are shown in FIG. 10 for the purposes of illustration. Server 1010, for example, may be an extraction engine.

Each of these devices, such as server 1010 and display 1020, may include at least one processor or control unit or module, respectively indicated as 1011 and 1021. At least one memory may be provided in each device, and indicated as 1012 and 1022, respectively. The memory may include computer program instructions or computer code contained therein. One or more transceiver 1013 and 1023 may be provided, and each device may also include an antenna, respectively illustrated as 1014 and 1024. Although only one antenna each is shown, many antennas and multiple antenna elements may be provided to each of the devices. Server 1010 and display 1020 may be additionally configured for wired communication, in addition to wireless communication, and in such a case antennas 1014 and 1024 may illustrate any form of communication hardware, without being limited to merely an antenna.

Transceivers 1013 and 1023 may each, independently, be a transmitter, a receiver, or both a transmitter and a receiver, or a unit or device that may be configured both for transmission and reception. In other embodiments, the devices may have at least one separate receiver or transmitter. The transmitter and/or receiver (as far as radio parts are concerned) may also be implemented as a remote radio head which is not located in the device itself, but in a mast, for example. One or more functionalities may also be implemented as virtual application(s) in software that can run on a server.

In some embodiments, an apparatus, such as a server or display, may include means for carrying out embodiments described above in relation to FIGS. 1-9. In certain embodiments, at least one memory including computer program code can be configured to, with the at least one processor, cause the apparatus at least to perform any of the processes described herein.

Processors 1011 and 1021 may be embodied by any computational or data processing device, such as a central processing unit (CPU), digital signal processor (DSP), application specific integrated circuit (ASIC), programmable logic devices (PLDs), field programmable gate arrays (FPGAs), digitally enhanced circuits, or comparable device or a combination thereof. The processors may be implemented as a single controller, or a plurality of controllers or processors.

For firmware or software, the implementation may include modules or unit of at least one chip set (for example, procedures, functions, and so on). Memories 1012 and 1022 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate therefrom. Furthermore, the computer program instructions may be stored in the memory and which may be processed by the processors can be any suitable form of computer program code, for example, a compiled or interpreted computer program written in any suitable programming language. The memory or data storage entity is typically internal but may also be external or a combination thereof, such as in the case when additional memory capacity is obtained from a service provider. The memory may be fixed or removable.

The memory and the computer program instructions may be configured, with the processor for the particular device, to cause a hardware apparatus such as server 1010 or display 1020, to perform any of the processes described above. Therefore, in certain embodiments, a non-transitory computer-readable medium may be encoded with computer instructions or one or more computer program (such as added or updated software routine, applet or macro) that, when executed in hardware, may perform a process such as one of the processes described herein. Computer programs may be coded by a programming language, which may be a high-level programming language, such as objective-C, C, C++, C#, Java, etc., or a low-level programming language, such as a machine language, or assembler. Alternatively, certain embodiments may be performed entirely in hardware.

The above embodiments may provide for significant improvements to the functioning of the extraction engine. Specifically, certain embodiments may allow for use of machine learning to update a lexical knowledge base used to evaluate or process a plurality of text included in one or more documents. The updating of the lexical knowledge may either be supervised or unsupervised. Certain embodiments may also allow for use of machine learning to update a set of Semantic Vector Rules that may be used to evaluate a plurality of text in a document.

The features, structures, or characteristics of certain embodiments described throughout this specification may be combined in any suitable manner in one or more embodiments. For example, the usage of the phrases “certain embodiments,” “some embodiments,” “other embodiments,” or other similar language, throughout this specification refers to the fact that a particular feature, structure, or characteristic described in connection with the embodiment may be included in at least one embodiment of the present invention. Thus, appearance of the phrases “in certain embodiments,” “in some embodiments,” “in other embodiments,” or other similar language, throughout this specification does not necessarily refer to the same group of embodiments, and the described features, structures, or characteristics may be combined in any suitable manner in one or more embodiments.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

We claim:

1. A method, comprising:
analyzing a set of documents including a plurality of text;
extracting information from the plurality of text based on a lexicon; and
updating the lexicon with at least one new term based on one or more semantic vector rules.

2. The method according to claim 1, further comprising providing a report comprising the extracted information to a user, wherein the report comprises one or more semantic vector rules.

3. The method according to claim 2, further comprising displaying the report comprising the extracted information to the user.

4. The method according to any of claims 1-3, further comprising:
displaying the at least one new term to a user; and
requesting in a supervised mode for the user to affirm or not affirm the at least one new term.

5. The method according to claim 3, wherein displaying of the report occurs after the analyzing of the plurality of text.

6. The method according to any of claims 1-5, further comprising
updating the lexicon with the at least one new term in an unsupervised mode,
wherein the updating occurs during the analyzing of the plurality of text.

7. The method according to any of claims 1-6, wherein a semantic rule state evaluation is based on shared context.

8. The method according to claim 2, wherein the report comprises a trace back illustrating the one or more semantic rules used to extract the information.

9. The method according to any of claims 1-8, wherein the extracted information comprises one or more entities.

10. An apparatus, comprising:
at least one processor; and
at least one memory including computer program code,
wherein the at least one memory and the computer program code are configured to, with the at least one processor, cause the apparatus at least to:
analyze a set of documents including a plurality of text;
extract information from the plurality of text based on a lexicon; and
update the lexicon with at least one new term based on one or more semantic vector rules.

11. The apparatus according to claim 10, wherein the at least one memory and the computer program code are further configured to, with the at least one processor, cause the apparatus at least to provide a report comprising the extracted information to a user, wherein the report comprises one or more semantic vector rules.

12. The apparatus according to claim 11, wherein the at least one memory and the computer program code are further configured to, with the at least one processor, cause the apparatus at least to display the report comprising the extracted information to the user.

13. The apparatus according to any of claims 10-12, wherein the at least one memory and the computer program code are further configured to, with the at least one processor, cause the apparatus at least to:
display the at least one new term to a user; and
request in a supervised mode for the user to affirm or not affirm the at least one new term.

14. The apparatus according to claim 12, wherein displaying of the report occurs after the analyzing of the plurality of text.

15. The apparatus according to any of claims 10-14, wherein the at least one memory and the computer program code are further configured to, with the at least one processor, cause the apparatus at least to
update the lexicon with the at least one new term in an unsupervised mode,
wherein the updating occurs during the analyzing of the plurality of text.

16. The apparatus according to any of claims 10-15, wherein a semantic rule state evaluation is based on shared context.

17. The apparatus according to claim 11, wherein the report comprises a trace back illustrating the one or more semantic rules used to extract the information.

18. The apparatus according to any of claims 10-17, wherein the extracted information comprises one or more entities.

19. An apparatus, comprising:
means for analyzing a set of documents including a plurality of text;
means for extracting information from the plurality of text based on a lexicon; and
means for updating the lexicon with at least one new term based on one or more semantic vector rules.

20. A non-transitory computer-readable medium encoding instructions that, when executed in hardware, perform a process, the process comprising:
analyzing a set of documents including a plurality of text;
extracting information from the plurality of text based on a lexicon; and
updating the lexicon with at least one new term based on one or more semantic vector rules.

21. A computer program product encoding instructions for performing a process, the process comprising:
analyzing a set of documents including a plurality of text;
extracting information from the plurality of text based on a lexicon; and
updating the lexicon with at least one new term based on one or more semantic vector rules.

22. A computer program, embodied on a non-transitory computer readable medium, the computer program, when executed by a processor, causes the processor to:
analyze a set of documents including a plurality of text;
extract information from the plurality of text based on a lexicon; and
update the lexicon with at least one new term based on one or more semantic vector rules.
